(19) United States
(12) Patent Application Publication
(10) Pub. No.: US 2017/0132722 A1
(43) Pub. Date: May 11, 2017

(54) REAL-TIME SOCIAL ENERGY BEHAVIOURAL NETWORKS

(71) Applicants: VASSILIS NIKOLOPOULOS, VYRONAS (GR); KONSTANTINOS STAIKOS, MAROUSI (GR)

(72) Inventors: VASSILIS NIKOLOPOULOS, VYRONAS (GR); KONSTANTINOS STAIKOS, MAROUSI (GR)

(21) Appl. No.: 13/723,194

(22) Filed: Dec. 20, 2012

Related U.S. Application Data
(60) Provisional application No. 61/577,678, filed on Dec. 20, 2011.

(51) Int. Cl. G06Q 50/00; G06Q 50/06; G05B 15/02

(52) U.S. Cl. CPC G06Q 50/01; G05B 15/02; G06Q 50/06

(57) ABSTRACT

Techniques for controlling energy efficiency and demand response are disclosed. According to the disclosure, a first set of values associated with a first user comprising real-time energy consumption metrics and a second set of values associated with the first user comprising real-time social networking metrics are identified. The two sets of values are correlated to create a personalized set of incentives selected to stimulate deviation of the energy consumption of the first user. In a variable cluster of users the two sets are correlated in order to assign automatically adaptive incentives from a social energy game scenario pool for motivation control. Based on the above results and the correlated energy and social metrics, specific incentives from a pool of incentives are selected.

### TECHNICAL FIELD

The present disclosure relates generally to energy consumption management and more particularly to techniques for controlling energy efficiency and demand response.

### BACKGROUND

Energy consumption is characterized by peaks, averages and dynamic trends. There are limits to how accurately statistical models can predict and analyze the demand, especial with these models attempt to predict and analyze the demand in real time. Currently energy providers are obliged to plan capacity based on peak energy demand models. This has a negative effect in pricing and reduces efficiency.

One approach in the art to improving the situation with small users is to install smart meters at homes and small businesses. While the primary motivation for doing so is to enable interval-based usage measurement and the communication of interval-based prices to the users, it is also possible to provide the consumer with much more information on how she/he uses energy than was possible without a smart meter.

Given this granular usage information, utilities and some third parties also hope to be able to send signals, either via pricing or “code red” messages (which ask consumers to turn off unnecessary loads due to grid constraints), or both. In some cases, third parties seek to provide visibility and control to utilities so that, when consumers allow it, the utilities can turn loads off during peak demand to manage the peak. A related method involves the use of “gateway” devices to access a consumer's (again, referring to residences, businesses, and institutions) home area networks (HAN) to communicate with or turn off local devices.

It is a disadvantage of the techniques known in the art that the consumers and small businesses are not, in general, provided with any substantial financial incentives to participate in demand reduction programs (other than merely by saving because they use less power). As a result, demand response services were not efficient in the home consumer market space. Also, price incentives were not always efficient due to the lack of awareness and the lack of real time information has limited the effectiveness of price incentive models in order to drive behavioral motivation and reach energy reduction targets by engaging efficiently consumers.

It is desirable to introduce systems and methods that give the consumer incentives to be energy efficient and aware in real time of the results of their actions for demand response and for reducing energy consumption.

### BRIEF DESCRIPTION OF THE DRAWINGS

FIG. 1 is a functional block level diagram of a social energy behavioral system according to an exemplary embodiment.

FIG. 2 is a flow diagram of a social energy gaming process according to another exemplary embodiment.

FIG. 3 is a flow diagram of a customer credification process according to another exemplary embodiment.

FIG. 4 is a block level diagram of the web inter-connection layers in a social energy gaming process according to another exemplary embodiment.

FIG. 5 shows a core technical architecture for the cloud infrastructure of a social energy behavioral system according to another exemplary embodiment

FIG. 6 shows the basic software components required in a complete social energy gaming process scenario.

FIG. 7 is an illustration of an energy social behavioral system according to an exemplary embodiment.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

The present disclosure refers to systems and methods that give to an energy consumer incentives to be energy efficient and aware in real time of the results of their actions for demand response and for reducing energy consumption. More specifically, the present disclosure is directed to a system and method for automatic adaptive smart mapping of energy and social profile metrics of the energy consumer in time. A sub-module of the system analyzes the real-time energy consumption and a number of dynamic statistical indices and metrics and at the same time another sub-module analyzes the social profile and social trends of the same energy customer from social networks (ie. facebook). A set of algorithms and game mechanics/scenarios, based on real-time smart metering data, engage the energy consumer in a continuous social energy game by offering energy efficiency services and personalized incentives to save energy and to follow Demand response signals or demand response programs. By using social competitions, social group benchmarking and social interfacing, the energy consumer can interact with the service in real-time, as if playing a game with real energy data, using mobile apps or other Web 2.0 techniques, and the system offers automatic adaptive incentives to the energy consumer, according to his social profile and his habits or social behavior. By using this specific approach, energy consumers are highly motivated to save energy and follow demand response services in real-time, by receiving these specific automatic social incentives as they save energy and as they optimize their demand response gaming profile in the social energy game scenario Thus, a motivation behavioral model using badges and social rewards is presented.

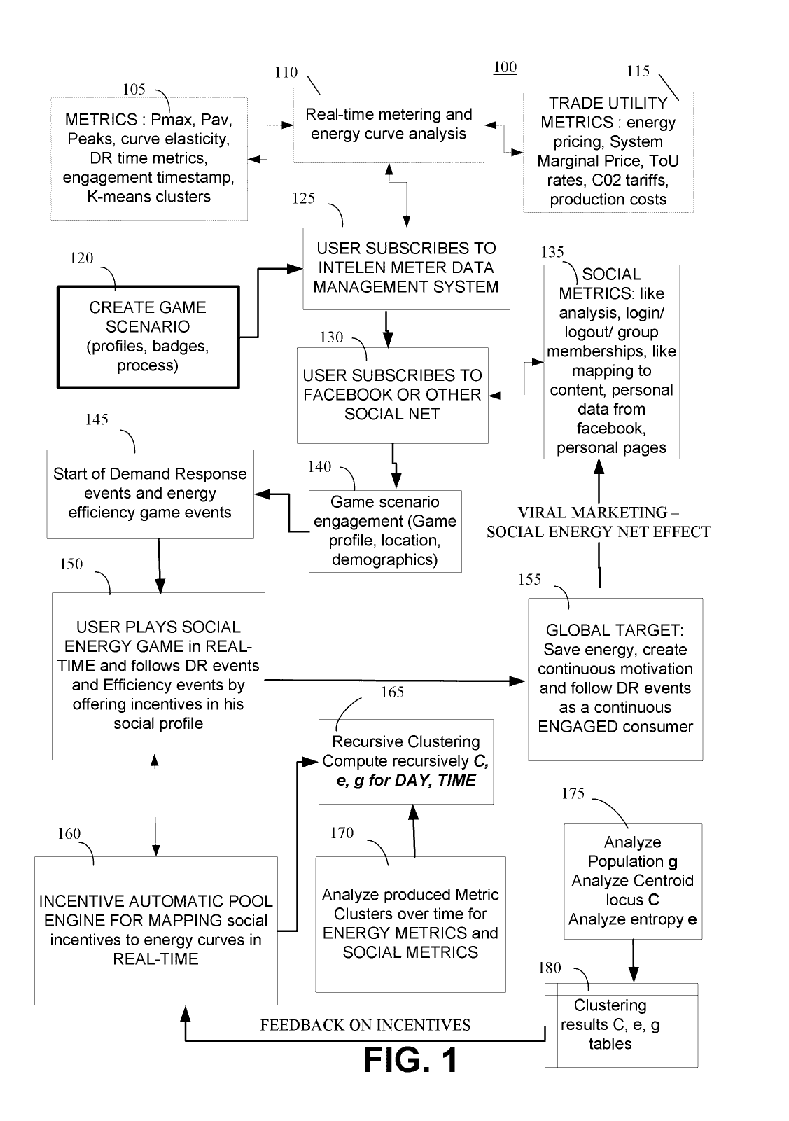

FIG. 1 is a functional block level diagram of a social energy behavioral system according to an exemplary embodiment. In block 105, a set of energy metrics from the consumer side is stored. The set may include one or more of the following metrics: (i) Maximum power or energy consumption (Pmax); (ii) Average power or energy consumption (Pay); (iii) Peak value of energy demand (Peak); (iv) curve elasticity value of demand or consumption; (v) Demand Response time metrics; (vi) engagement timestamp; and (vii) K-means clusters. In block 115, a set of trade utility metrics from the utility side is stored. This set may include one or more of the following metrics: (i) energy pricing, (ii) System Marginal Price; (iii) ToU rates; CO₂ tariffs; and (v) production costs. In block 110, a real-time metering and energy curve analysis is performed. New values for consumer metrics and utility metrics are identified as part of the real-time metering function and an energy curve analysis is performed with input from both real-time data and the stored metrics of blocks 105 and 115. The set of metrics stored in blocks 105 and 115 is updated with the real-time data from the metering function of block 110. In block 125, a user subscribes to a meter data management system (MDMS). MDMS includes a game scenario, i.e. a set of rules for participating in a social energy competition. This set of rules is defined in block 120, where a game scenario is created including user profiles, rewards and gaming process steps. In block 130, the user subscribes to a social networking platform (e.g. Facebook) if the user is not already member. The social networking platform stores a set of social metrics. The set of social metrics may include one or more of the following metrics: (i) like analysis; (ii) login-logout data; (iii) group memberships; (iv) like mapping to content; (v) personal data; and (vi) personal pages. This set of social metrics is updated each time the user is using the social networking platform. In block 140, the user engages in the game scenario by creating a game profile based on the user's location and the user's demographics. In block 145, the game starts and the user is offered a set of demand response and energy efficiency events. In block 150, the user participates in the social energy game in real time by following DR events and energy efficiency events. The user is offered a set of incentives based on his social profile. The set of incentives is produced in block 160, where an incentive automatic pool engine maps social incentives to energy curves in real-time. To perform this automatic mapping a social energy algorithm is used. In block 165, a recursive clustering function is performed where a set of values C, e and g for a particular day and time are calculated recursively according to the following formulas:

C_{i,j}^{N}=[x_{i,j}y_{i,j}]_{g}_{_{N}}

Equation 1 represents the result of a recursive k-means clustering algorithm that is being executed in real-time by the Meter Data Management system. C is the final centroid position of the k-means output (x,y coordinates in a Cartesian system) for the analysis of the above metrics (Pav, Pmax). Indication of the centroid position gives a good visual of the resulting cluster with all energy consumers inside this dynamic cluster, having common energy performance indicators (Pav/Pmax). The cluster has the population of all correlated customers that have common time-variant energy profile and metrics. The resulting customer list of the cluster is variant according to the time of the energy metering and profile.

$${e}_{i , j}^{N} = ( \frac{1}{n} {\sum }_{i ∈ d ( n )} \vec{E} d {\vert μ \vert}_{N} )$$

Equation 2 represents the entropy e of the above resulted cluster. The entropy is equal to the average Euclidean distance Ed of each cluster member (in total n) and the centroid. It gives a metric of the cluster's dynamic density over time.

g_{N=1}={m₁,m₂ . . . mₙ}εg

Equation 3 represents the total populations g in each cluster. The populations in each cluster represent the customer groups that have common energy characteristics (metrics) in this specific timeframe of the data analysis.

Then, in block 170, the produced metric clusters are analyzed over time for the given energy metrics and social metrics. In block 175, the population g, the Centroid locus C and the entropy e are analyzed. In block 180, the clustering results of C, e and g are stored in tables and this table is used as feedback to the incentive automatic pool engine of block 160 to produce new incentives. The global target of the system is shown in block 155. The global target is to save energy, create continuous motivation and follow DR events as a continuous engaged consumer.

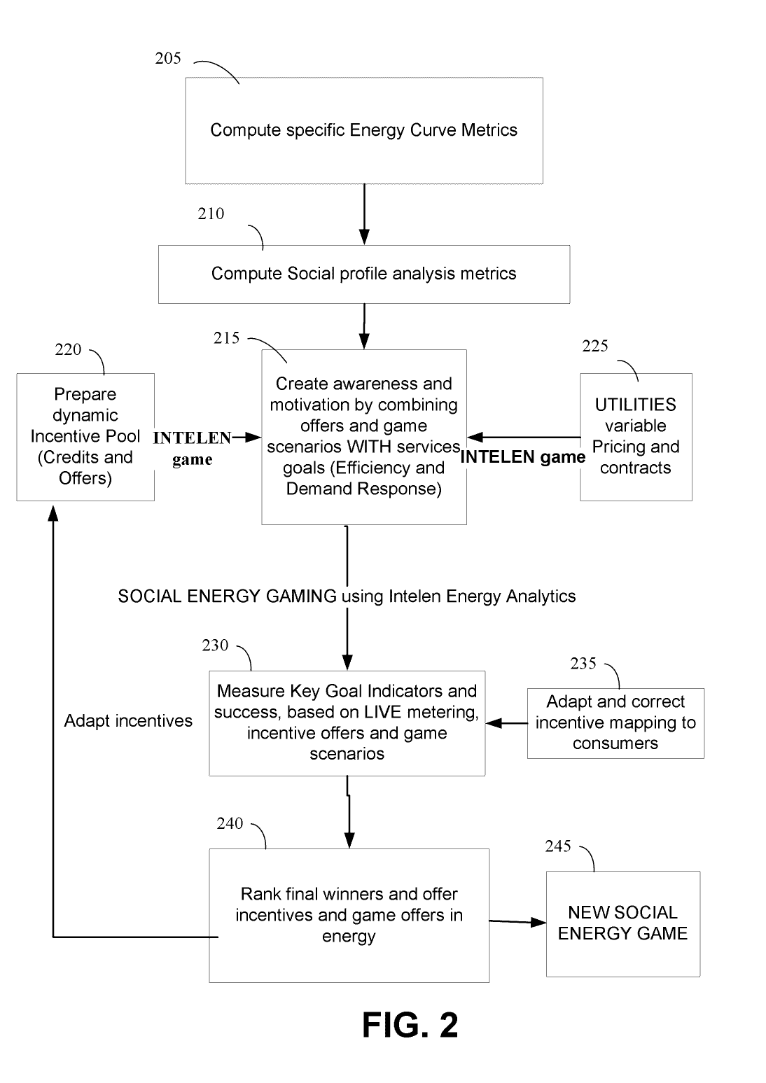

FIG. 2 is a flow diagram of a social energy gaming process according to another exemplary embodiment. In first step 205, specific energy curve metrics are computed. Then, in step 210 social profile analysis metrics are computed. In step 215 a gaming process is initiated with the purpose to create awareness and offer motivation to the energy consumer by combining offers and game scenarios with utility service goals such as energy efficiency and demand response. The gaming process receives an input from functional block 220, where a dynamic incentive pool is prepared with credits and/or offers for the energy consumer. Another input is received from functional block 225, where a utility company provides data related to variable pricing and contracts. In step 230, key goal indicators are measures in real time during the execution of the gaming process. The measures are based on real time live metering, the incentive offers and the gaming scenarios. The measuring step 230 receives also input from functional block 235, based on adaptations and corrections in the incentive mapping to consumers. In step 240, the final winners of the gaming process are ranked and offered incentives and game offers in energy. After the end of the gaming process the dynamic incentives pool of functional block 220 is updated and a new social energy game is ready to start in step 245.

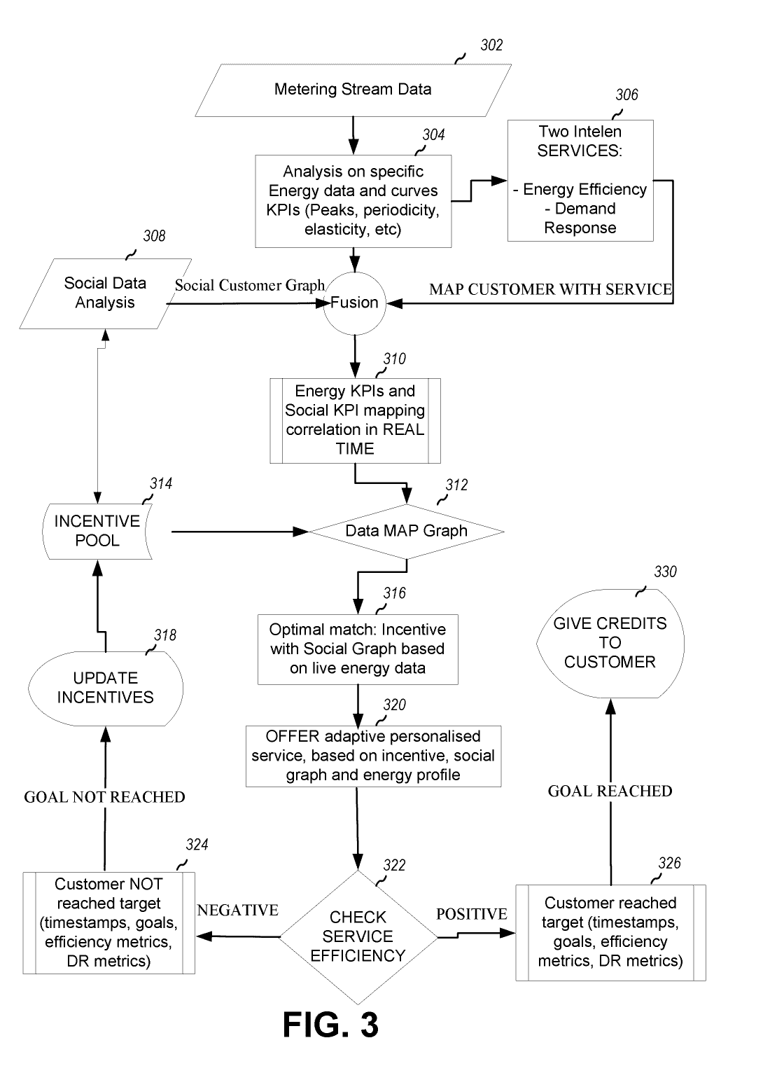

FIG. 3 is a flow diagram of a customer credification process according to another exemplary embodiment. In step 302, energy metering stream data is identified. Then, in step 304, the data is analyzed and specific energy metrics (energy data and curves KPIs) are identified. The metrics may include one or more of peaks, periodicity, elasticity etc. In step 306, one of the services energy efficiency or demand response is selected and the customer is mapped to the selected service. In step 308, social data of the customer is analyzed. The result of this analysis generates a social customer graph. This graph is fused with the energy metrics and the selected service. In step 310, Energy KPIs and Social KPIs is correlated in real time and provided to step 312. An incentive from Incentive pool 314 is used to create a data map graph in step 312. In step 316, an optimal match is performed of the social graph with the incentive based on the live energy data. In step 320, the customer is offered an adaptive personalized service based on the selected incentive, the social graph and the energy profile. In step 322, a check is performed if the service has been efficient. If the result of the check is positive, then in step 326, the customer is identified as having reached predefined target as indicated by timestamps, goals, efficiency metrics and/or DR metrics. Because the goal is reached, the customer is given credits in final step 330. If the result of the check is negative, then in step 324, the customer is identified as NOT having reached predefined target as indicated by timestamps, goals, efficiency metrics and/or DR metrics. Because the goal is not reached, then, in step 318, the incentives are updated in incentive pool 314.

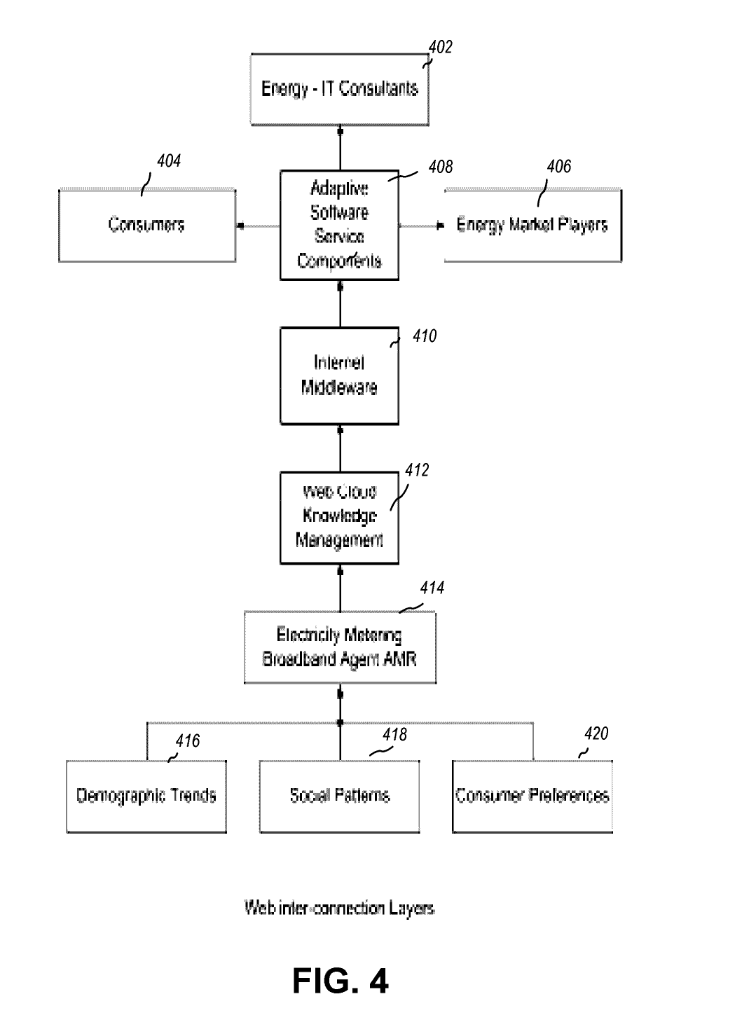

FIG. 4 is a block level diagram of the web inter-connection layers in a social energy gaming process according to another exemplary embodiment. At a first layer, the lower layer as illustrated in FIG. 4, existing demographic trends 416, Social patterns 418 and consumer preferences 420. The constituents of the first layer are connected to the second layer shown as Electricity metering broadband agent AMR 414. Next, in the third layer, lies the web cloud knowledge management 412. The third layer is connected with the fourth layer illustrated as internet middleware 410. Internet middleware 410 is connected to adaptive software service components 408 at the fifth layer. At this layer lie also consumers 404 and energy market players 406. At the top layer lie energy and IT consultants 402.

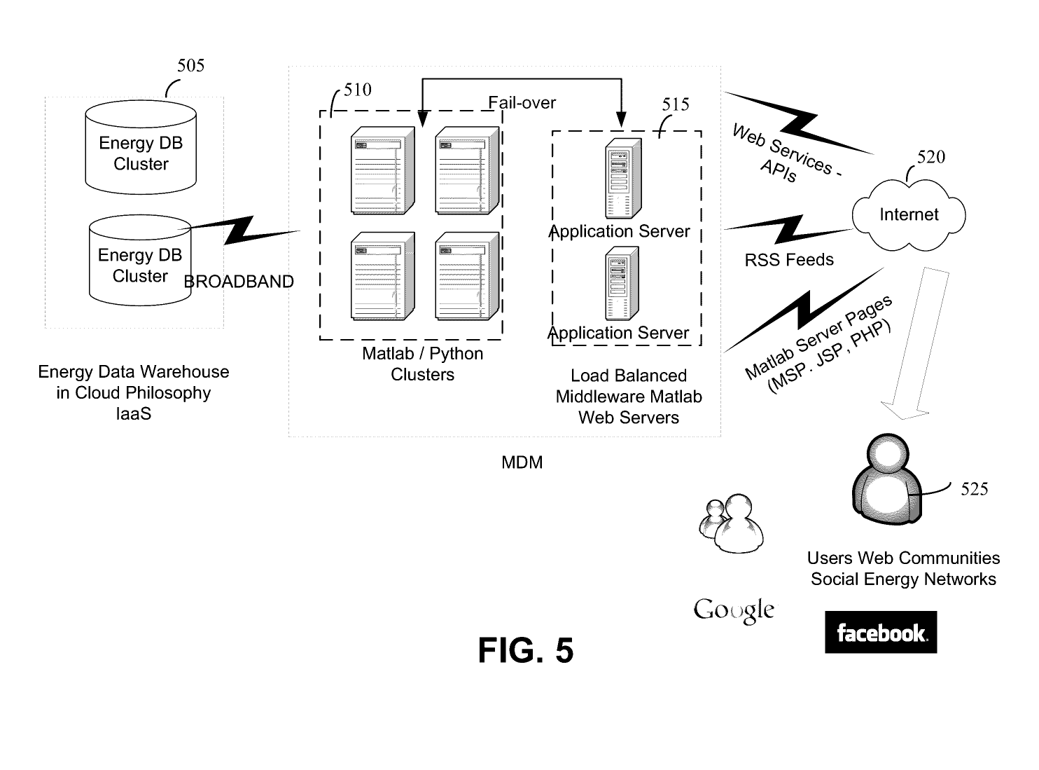

FIG. 5 shows a core technical architecture for the cloud infrastructure of a social energy behavioral system according to another exemplary embodiment. More specifically, FIG. 5 is a diagram indicating the technical topology of the system. In the overall model, the storage base 505 (Energy DB), is where the meter data are stored, coming from the smart metering (AMR) infrastructure. In the application Server cluster 510 & 515 (Meter Data Management and fail-over procedure in the Cloud), the core intelligence is included for the analysis, clustering and correlation of the energy consumption data, based on the equations described with reference to FIG. 1. Finally, the presentation layer 525 incorporates any possible digital means for the personalized appearance of the energy graphs and results, by using the Internet layer 520 as a means for AMR data transfer.

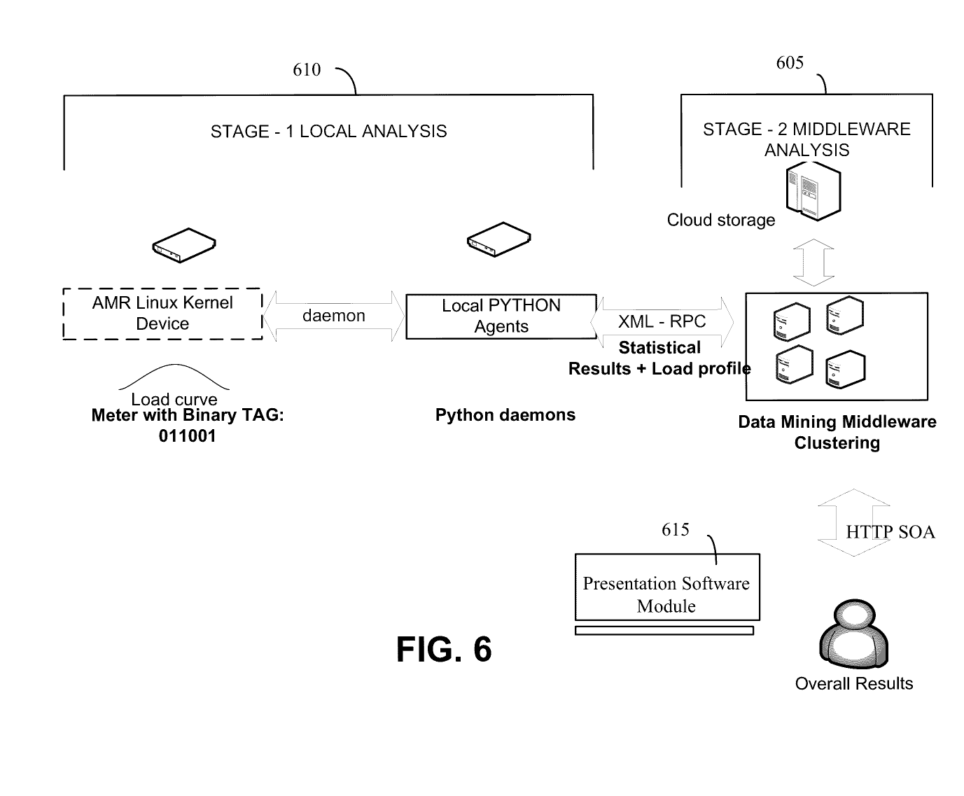

FIG. 6 shows the basic software components required in a complete social energy gaming process scenario. More specifically, FIG. 6 shows how the software components work together. Initially, there is a description of the software sequential procedure for the analysis of energy loads coming from the smart meter. Initial local analysis on the energy curve is first executed on the meter device 605 (Local Analysis) using some Python and Linux algorithms that are executed locally and have connection with the Cloud MDM system. Then a second level clustering analysis (energy and social metrics) is automatically executed in the Meter Data Management middleware 610, on the stream data published through web services methodologies (XML SOA). Finally, the results are incorporated in the presentation software module 615 (CMS, Mobile Apps, Web) for the visualization and user integration.

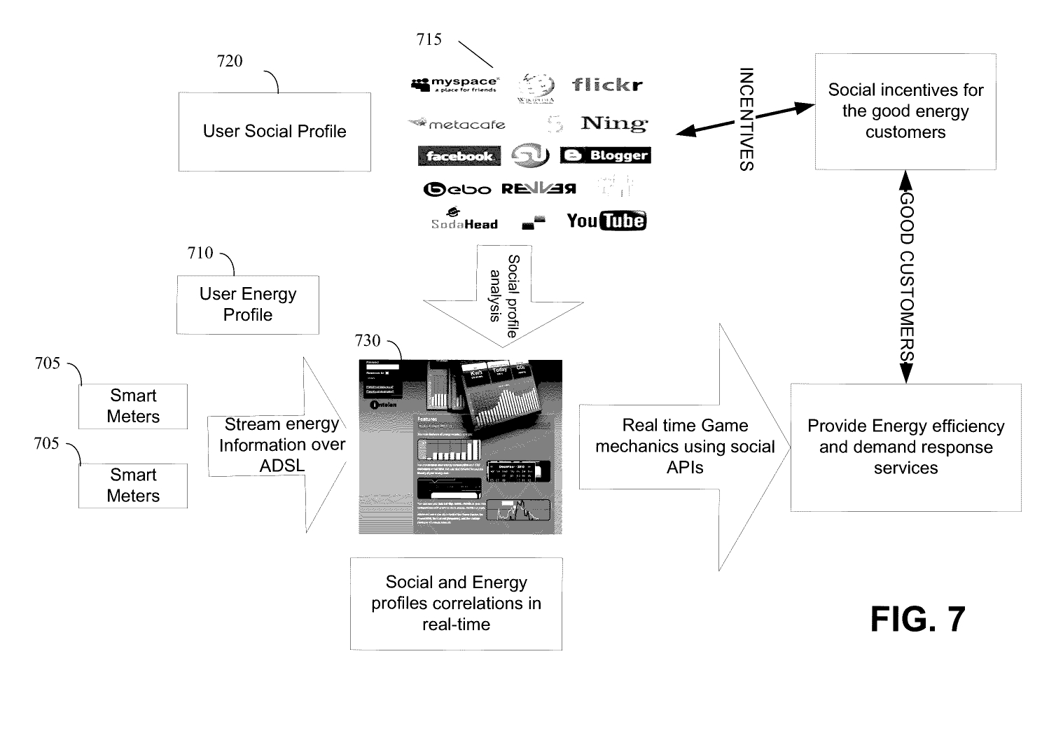

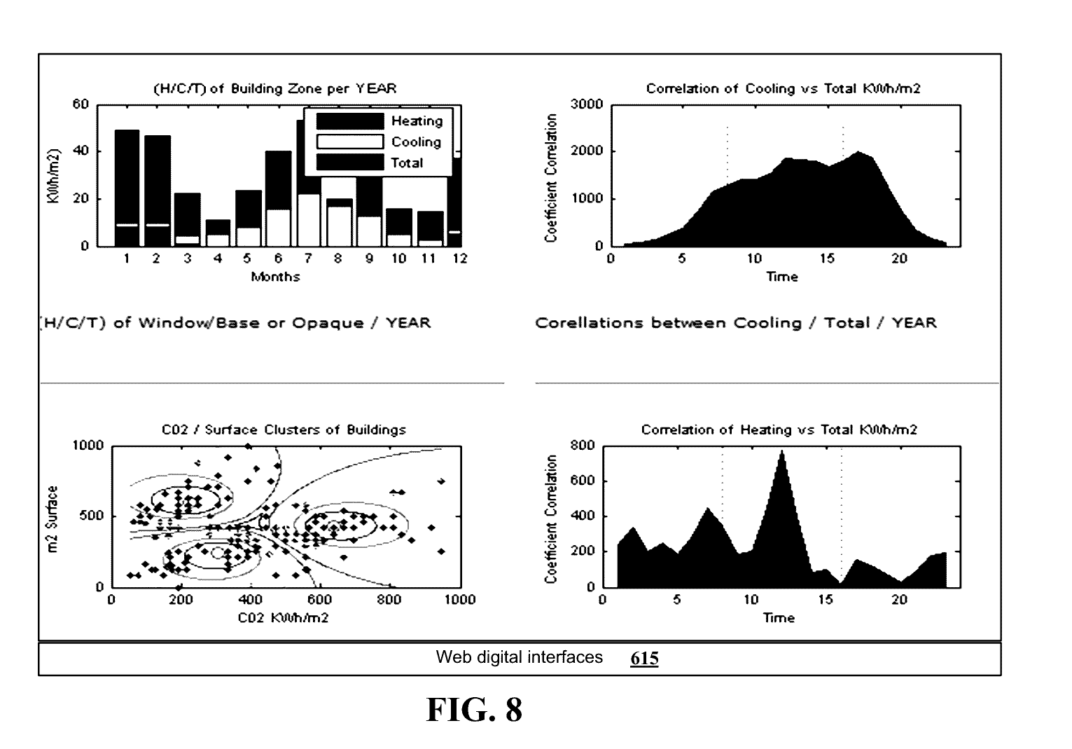

FIG. 7 is an illustration of an energy social behavioral system according to an exemplary embodiment. On the left part of FIG. 7 are shown smart meters 705 installed at a user's premises to collect energy information and stream this energy information over communication lines (e.g. ADSL). This energy information will develop energy profile 710 of the user. Energy profile is analyzed to provide energy profile metrics. On the upper part of FIG. 7, social networks (e.g. Facebook, myspace etc.) collect social information of a social user to generate social profile 720 of the user. Social profile is analyzed to provide social profile metrics. Energy profile metrics and social profile metrics are correlated in real time using social energy management system 730. This correlation initiates a social energy game in real time using social APIs. The purpose is to provide energy efficiency and demand response services in real time by offering social incentives to good energy customers (or users) as shown in the right part of FIG. 7. These incentives may be offered through the social networking platforms the user is already familiar with.

In an exemplary embodiment, a web enabled energy metering device (AMR device), adapted to be connected to the internet, is installed at the premises of a number of energy consumers. The AMR device monitors and logs at least four distinct energy consumption parameters. The AMR device is able to provide energy values for the following parameters, from every 6 sec up to 15 min: Energy consumption (KWh), Power factor (cos f), Power Demand (KW), Voltage and currents (Volts and Amps). Energy values are logged internally and are available through a web interface in order to be used by external telemetry systems and software AMR agents, as an embedded software service. The algorithm is performed in a distributed way, using the on-board embedded Linux kernels on the smart meters. By correlating the centroid position C with the entropy calculation e and the population of the cluster (g members), an efficient and clear view of the members-customers and how their consumption pattern moves in time is achieved, always correlated with the initial KPI (Pav/Pmax). MIN and MAX values are automatically indicated and result from the Python agent, executed locally in the meter kernel. By combining, at the same time, specific social profile metrics (i.e. number of likes in sports, hobbies, memberships, communities member, demographics, etc.) then the above energy metric results are fused with social metrics in real-time. Each cluster is dynamically changing its performance by day/hour/minute and by execution time. By measuring the variables of the centroid position, the entropy and the population alterations (customer members of each cluster), important results are produced for some specific customer groups, in order to identify identical trends of consumers that have similar time-variant consumption profile. By having this important information and their time-variant social graph metrics, a utility or energy services company can group and offer personalised adaptive services and real-time game-scenario incentives (leadership board that adapts in the cluster) according to the variable consumption profile of a social group/community of people. The relevant cluster moves in time, indicating the variable consumption and fused social pattern. Customers that are members of the specific cluster have common consumption and social patterns and possibly other statistical indices (standard deviation) that vary over time. This fused adaptability is unique, since having adaptive and variable clusters and KPIs, it is possible to identify common consumptions patterns, common social patterns and fuse them in order to assign automatically adaptive incentives from a social energy game scenario pool to variable customers for motivation control. So, based on the above results and the fused energy and social metrics on the dynamic centroids, specific incentives from a pool are automatically assigned to the specified customers, members of the specific clusters, indicating a variable social incentive mechanism that automatically identifies energy efficiency or DR opportunities.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of controlling energy consumption comprising:
identifying a first set of values associated with a first user comprising real-time energy consumption metrics;
identifying a second set of values associated with the first user comprising real-time social networking metrics; and
correlating the first set of values with the second set of values to create a personalized set of incentives selected to stimulate deviation of the energy consumption of the first user.

2. The method of claim 1, further comprising automatically rewarding the first user when the deviation of the energy consumption of the first user is ranked higher than the deviation of a second user.

3. The method of claim 2, where the first user and the second user subscribe to a meter data management system (MDMS) and a social networking platform (SNP).

4. The method of claim 3, further comprising storing the first set of values in the MDMS to create an energy profile and storing the second set of values in the SNP to create a social profile.

5. The method of claim 4, further comprising mapping in real-time the personalized set of incentives to an energy curve to select an incentive from the personalized set of incentives and to update the personalized set of incentives.

6. The method of claim 5, further comprising computing recursively a population g, a Centroid Locus position C and an entropy e, for the first or the second set of values.

7. The method of claim 6, further comprising analyzing the recursively computed population g, the centroid loicus c and the entropy g to generate a set of feedback values for the incentive automatic pool engine.

8. A system for controlling energy consumption comprising:
means for identifying a first set of values associated with a first user comprising real-time energy consumption metrics;
means for identifying a second set of values associated with the first user comprising real-time social networking metrics; and
means for correlating the first set of values with the second set of values to create a personalized set of incentives selected to stimulate deviation of the energy consumption of the first user.

9. The system of claim 8, further comprising means for automatically rewarding the first user when the deviation of the energy consumption of the first user is ranked higher than the deviation of a second user.

10. The system of claim 9, where the first user and the second user subscribe to a meter data management system (MDMS) and a social networking platform (SNP).

11. The system of claim 10, further comprising means for storing the first set of values in the MDMS to create an energy profile and storing the second set of values in the SNP to create a social profile.

12. The system of claim 11, further comprising means for mapping in real-time the personalized set of incentives to an energy curve to select an incentive from the personalized set of incentives and to update the personalized set of incentives.

13. The system of claim 12, further comprising means for computing recursively a population g, a Centroid Locus position C and an entropy e, for the first or the second set of values.

14. The system of claim 13, further comprising means for analyzing the recursively computed population g, the centroid loicus c and the entropy g to generate a set of feedback values for the incentive automatic pool engine.
